(19) United States
(12) Patent Application Publication
(10) Pub. No.: US 2004/0236600 A1
(43) Pub. Date: Nov. 25, 2004

(54) Method and apparatus for product-centric delivery of product user notices

(76) Inventor: Jack Ivan J'maev, Chino, CA (US)

Correspondence Address: Jack J'maev, Suite 110, 11800 CENTRAL AVE., CHINO, CA, 91710, US

(21) Appl. No.: 10/850,476

(22) Filed: May 19, 2004

Related U.S. Application Data
(63) Continuation-in-part of application No. 10/615,412, filed on Jul. 7, 2003.
(60) Provisional application No. 60/471,976, filed on May 19, 2003.

(51) Int. Cl. G06F 17/60

(52) U.S. Cl. 705/1

(57) ABSTRACT

Product notices are directed to a product notice receiver integrated into a manufactured product.

### RELATED APPLICATIONS

This present application is a continuation-in-part of application Ser. No. 10/615,412 filed on Jul. 7, 2003, entitled “Method and Apparatus for Receiving Product Notices”, by J'maev, currently pending, for which the priority date for this application is hereby claimed and which is hereby incorporated by reference herein in its entirety; this application further claims priority to provisional application Ser. No. 60/471,976 filed on May 19, 2003 also by J'maev entitled “Method and Apparatus for Product-Centric Delivery of Product Notices”.

### BACKGROUND

As already described in Applicant's co-pending application entitled “Method and Apparatus for Receiving Product Notices”, (application Ser. No. 10/615,412), prior-art product recall methods and their corresponding apparatus have heretofore been “user-centric”. By this term, Applicant again notes that all known art in the field of product recall relies on registration of users in order to deliver a product recall or other product notice to the user.

For example, Applicant notes that the now published patent application entitled “Method for Distributing Product Hazard Information” by Knegendorf (Publication Number 20030040929) describes a product recall method a apparatus that is limited by its first claim to include a step for identifying a user and then delivering a product hazard notice to that identified user. The problem with this, and all known methods for notifying a product user that a product may pose a potential hazard to either its user, a bystander or to personal property is that the user must be first “identified”. Herein is the problem—How is a user identified?

Prior art has relied on a user registration process where the user registers their name and contact information. This data is then correlated with a particular product. When a recall or other notice pertinent to the product is issued by the manufacturer, the contact data is retrieved from a database according to a product identifier that particularly identifies the product in question. In one known system, a product user provides the registration system an electronic mail (e-mail) address. When a recall or other product related notice needs to be disseminated, the system dispatches an e-mail message to the product user's then known e-mail address. This system still requires registration of product users and provides no sufficient means for updating or otherwise keeping the registration data current. In other methods, a user is encouraged to check a product recall database. This prior art method provides no actual notification—the user must proactively seek out any product safety (i.e. hazard) notices.

### SUMMARY

A method and apparatus for delivering a product notice to a product comprising production of a product and the association of a notice receiver with that produced product.

### BRIEF DESCRIPTION OF DRAWINGS

Several alternative embodiments will hereinafter be described in conjunction with the appended drawings and figures, wherein like numerals denote like elements, and in which:

FIG. 1 is a flow diagram that depicts one example method for delivering user notices to potential product users according to the method of the present invention;

FIG. 2 is a flow diagram that depicts one method for disabling a product notice according to the present invention;

FIG. 3 is a flow diagram that depicts one example alternative method for prompting a user for a recovery code;

FIG. 4 is a flow diagram that depicts one example method for providing a current user with a recovery code according to the present method;

FIG. 5 is a block diagram that depicts one example structure of a registration server according to the present invention;

FIG. 6 is a pictorial diagram of an example registration graphical user interface embodied as a web page;

FIG. 7 is a pictorial diagram of an example recovery code presentation GUI embodied as a web page;

FIG. 8 is a pictorial representation of a recovery code transaction table used by one embodiment of the invention to store recovery code transactions;

FIG. 9 is a block diagram of a one example embodiment of a product comprising a product notice receiver according to the present attention;

FIG. 10 is a block diagram of one example embodiment of a vibration based in-use detector according to the present invention;

FIG. 11 is a block diagram of one example embodiment of a power switch based in-use detector according to the present invention;

FIG. 12 is a pictorial diagram of a mechanical operation sensor based in-use detector according to the present invention;

FIG. 13A is a flow diagram that depicts additional process steps for conveying a recovery code in response to a user request received by the registration server according to the present invention;

FIG. 13B is a flow diagram that depicts an alternative method for receiving a recovery code in a product according to the present invention;

FIG. 14 is a pictorial representation of a notice message comprising a recovery signal according to the present invention;

FIG. 15 as a block diagram of a product notice receiver based on the incorporated reference and modified according to the teachings of the present invention; and

FIG. 16 to diagram that depicts one alternative method of associating a notice receiver with a product according to the present invention.

### DETAILED DESCRIPTION

What is needed is a means for delivering a product notice to a user that is not user-centric. According to the present invention, product notices are issued not to the user, but to a device associated with the product. This device is then used to present a product notice to a potential user. The present invention comprises a method for delivering “product-centric” notices to potential product users.

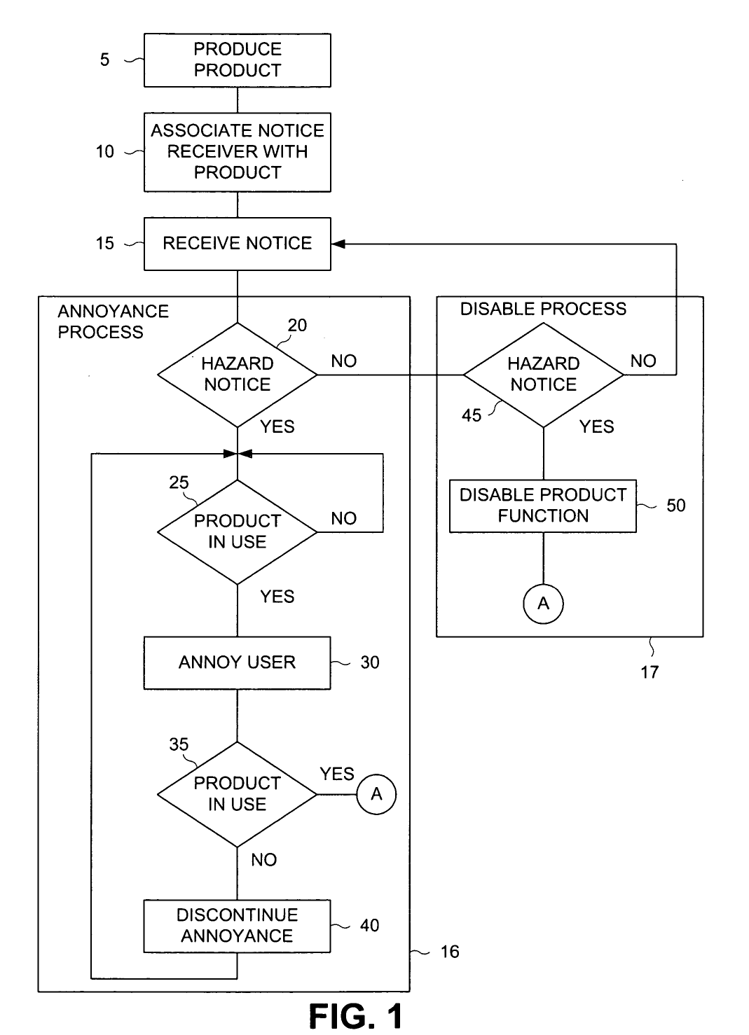

FIG. 1 is a flow diagram that depicts one example method for delivering user notices to potential product users according to the method of the present invention. According to one illustrative method, product user notices are delivered by producing a product (step 5) and then associating a notice receiver (step 10) with that particular product. According to one variation of the present method, a notice receiver is integrated with the product resulting in a single product assembly including the normal functionality of the product and the notice receiver. According to one alternative method, the notice receiver is further configured to respond to notice messages addressed to a particular product identifier. This may be accomplished by either programming the receiver with a product identifier or manufacturing the receiver with an embedded product identifier where a product identifier is described in the incorporated reference application. According to one illustrative method, the receiver that is associated with the product comprises a wireless device that is capable of receiving a message comprising a product notice. In yet another variation of the present method, the receiver comprises a wired device that is capable of receiving a notice by means of a physical medium. It should be noted that the notice receiver is fully described in the referenced co-pending application.

The implementation of such a method comprises a product that is integrated with a notice receiver. Examples of the types of products that are producible by the method of the present invention include, but are not limited to: automobiles and automotive tires, travel trailers, baby car seats, baby cribs, baby play gyms, baby strollers, toys, bicycles and tricycles, safety helmets, and motorcycles. Other items include electronic entertainment products including, but not limited to television sets, cable and satellite signal receivers (a.k.a. set top boxes), radio receivers, video players and/or recorders and digital versatile disk (DVD) players and/or recorders. Yet other products manufacturable by the present method include, but are not limited to computer products including computer desktop components, notebook computers, video displays and printers. Other products that are producible by the present invention include tools. Tools include, but are not limited to power drills (e.g. hand drills and drill presses), power saws (e.g. circular saws and jig-saws), lawnmowers, lathes, milling machines, tractors, agricultural combines. Other household products included in the scope of the present invention include, but are not limited to clothes washers and dryers, clothes irons (for pressing garments), ovens (e.g. conventional and microwave), coffee makers, curling irons, hot-tubs, and hot-water heaters. All of these various product examples that comprise a product function and a notice receiver are merely examples intended to illustrate the scope of the present invention and are not intended to limit the scope thereof.

The present method further provides for receipt of a notice signal (step 15). It should be noted that the means for receiving a notice is described in the referenced co-pending application. When such a notice signal is received (step 20), one illustrative method provides that a hazard notice be presented (step 30) to a user. This is typically done in a manner that serves to annoy the user, although this is optional. Typical means for annoying a user include, but are not limited to visual indicators and audible indicators. Any type of indication may be used. For example, a light or an audible indicator may be used. According to one alternative variation of the present method, the annoyance of the user (step 30) is only accomplished when the product is “in-use” by a user (step 25). In yet another alternative variation of the present method, product notice indication is suspended (step 40) when the product is not in use (step 35).

According to one example variation of the present method, product use is determined by means of detecting vibration levels experience by the product. This method may be used in a product such as a lawnmower or a baby car seat. When the product is in use, an accelerometer is used to determine vibration levels experienced by the product. When vibration exceeds a particular threshold, product use is inferred. In other products, product use is determined by sensing the state of electronic or electrical components in the functional portion of the product. When such electronic or electrical components are energized, the method of the present invention infers that the product is in use by a user. In yet other products, the operation of mechanical components, such as straps or latches are used to determine product use. Hence, a sensor detects the operation of such straps or latches and infers product use from the state of use of the strap or latch.

According to one alternative method of the present invention, a notice received by the notice receiver associated with the product comprises a disable command (step 45). In such an event, the method of the present invention provides for disabling the product function (step 50). According to one example product, a clothes iron is disabled from functioning when a disable command is received by means of the notice receiver. Disablement of the product function is generally accomplished by issuing a disable signal to the functional element of the product, but this is only one example of a disabling method.

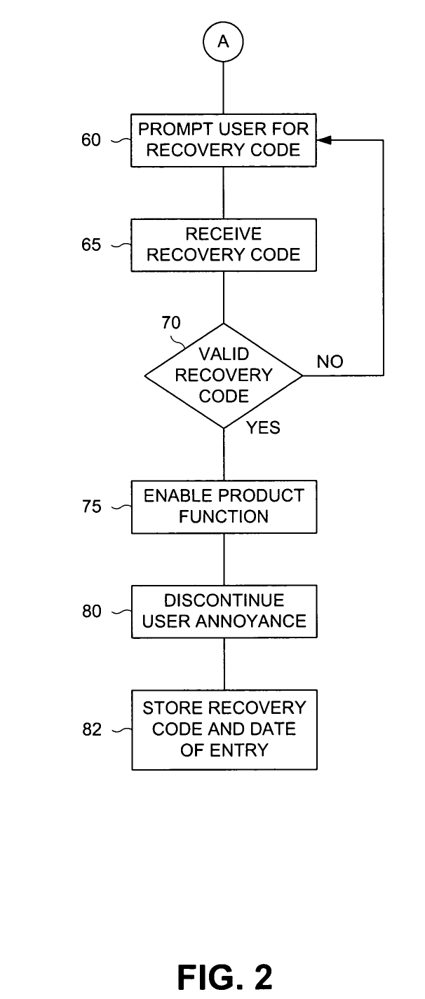

FIG. 2 is a flow diagram that depicts one method for disabling a product notice according to the present invention. This method is also applicable when the user needs to re-enable the product function after it has been disabled in response to a disable command received by the notice receiver. In order to disable the notice indication, one example method provides for prompting the user to enter a recovery code (step 60). The method then provides for accepting a recovery code from the user (step 65). The recovery code, according to one example method, comprises a single action code (e.g. pushing a button). According to an alternative method, a multi-action code is required. Hence, the user must take a specific sequence of actions in order to disable the notice. It should be noted that this sequence of actions is arbitrary and includes, but is not limited to entry of a numeric, alphabetic or alpha-numeric code on a keypad. Any suitable sequence of user actions may be detected. Once a valid recovery code is entered (step 70), any notice indication (e.g. annoyance) is disabled (step 75) and, if applicable, the product's function is re-enabled (step 80). It should be noted that a separate recovery code is required to re-enable product function according to one alternative method of the invention.

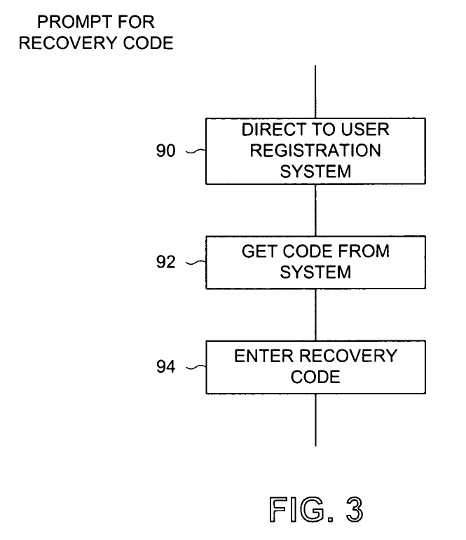

FIG. 3 is a flow diagram that depicts one example alternative method for prompting a user for a recovery code. According to this example method, the user is directed to consult a user registration server (step 90). Distinguishing this method from known art, the present method does not need to identify a user prior to delivery of a product notice. In the present invention, any current user is notified of a product notice and is prompted to register after receiving the notice. The user is not required to pre-register in order to receive the product notice. Once the user registers with the registration server, the user is provided a recovery code (step 92) and is directed to enter the recovery code into the product itself (step 94). One example method for directing the user to a registration server is to provide indicia on the product that the user is required to visit a web site on the internet when the annoyance (or other product notice) indicator is active or when the product has been disabled.

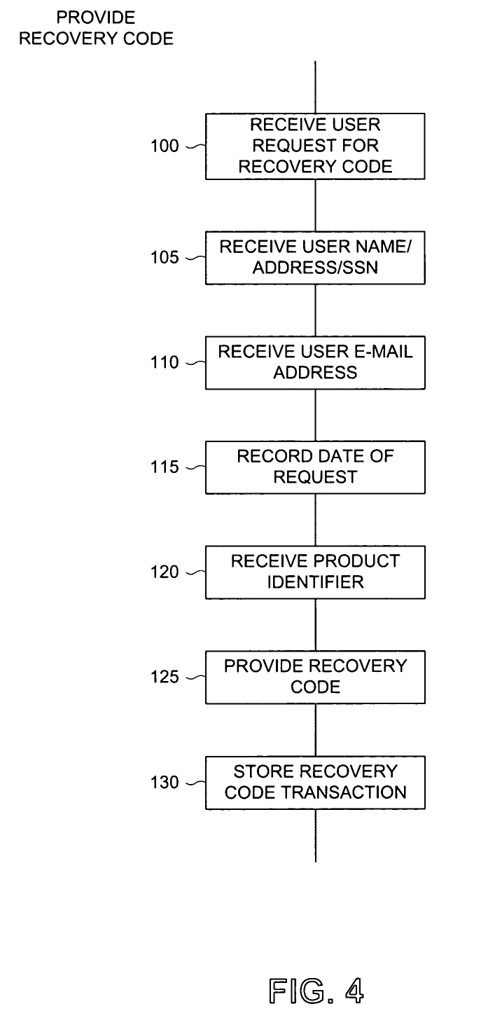

FIG. 4 is a flow diagram that depicts one example method for providing a current user with a recovery code according to the present method. According to this example method, a registration server receives a recovery code request from a current user (step 100). Again, in contrast to prior art “user-centric” methods, the current user has been notified that a product notice has been issued and is not required to pre-register with the server before receiving the product notice. The product notice is received in a “product-centric” manner by the notice receiver associated with the product.

Once the registration server receives a request for a recovery code, it responds by requesting that the user provide their name (step 105). According to one alternative method, the registration server requests the user to provide and then receives a user address (step 105). According to yet another alternative method, the registration server requests the user to provide and then receives a social security number. According to yet another alternative method, the registration server requests the user to provide and then receives a drivers license number. According to yet another alternative method, the registration server requests the user to provide and then receives a telephone number. According to yet another alternative method, the registration server requests the user to provide and then receives an e-mail address (step 110). Once such information is received by the registration server, it requests that the user provide and then receives a product identifier (step 120). Once the user provides the product identifier, the registration process provides the current user with a recovery code (step 125). The recovery code transaction is then stored for future reference (step 130) along with the date of the transaction (step 115).

FIG. 5 is a block diagram that depicts one example structure of a registration server according to the present invention. According to one embodiment of the present invention, a registration server 150 is connected to a computer network 160 (e.g. the Internet). A user can request a recovery code from the registration server 150. This request, according to one embodiment of the present invention, comprises a request for a web page. The server responds to the request by serving a registration web page. Information gathered by means of the registration web page is stored on computer readable medium 155. The art of gathering information by web-page is well known in the art and will not be detailed here.

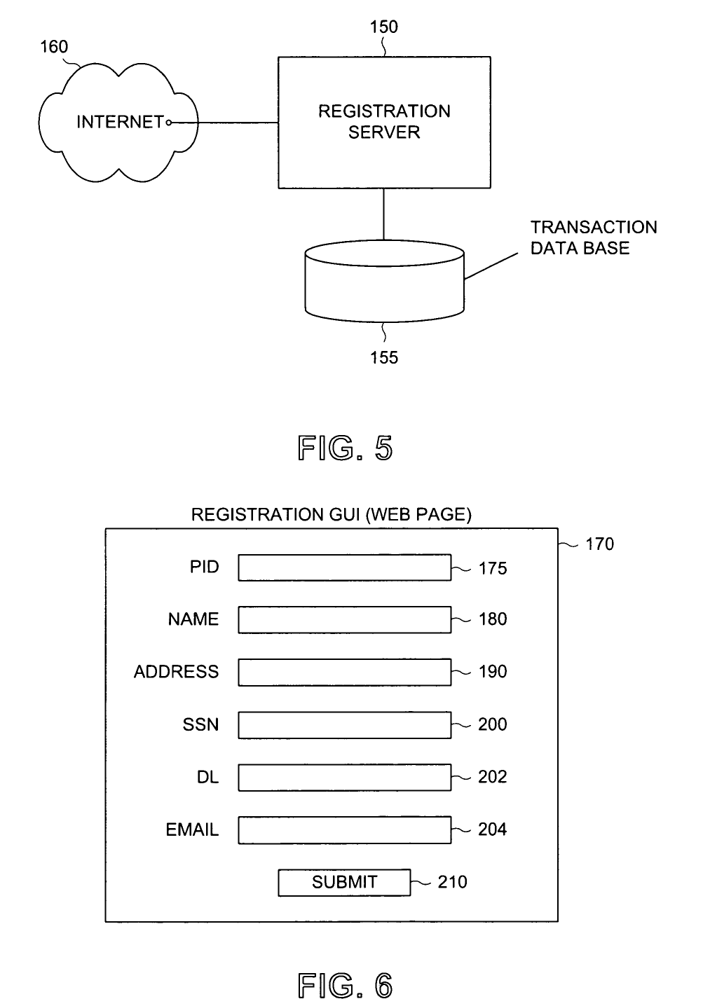

FIG. 6 is a pictorial diagram of an example registration graphical user interface embodied as a web page. According to this example embodiment, a user registration web page 170 comprises a product identifier data entry field 175 and a submit command button 210. According to one alternative embodiment of the invention, the user registration web page 170 further comprises a name data entry field 180. According to yet another alternative embodiment of the invention, the user registration web page 170 further comprises an address data entry field 190. According to yet another alternative embodiment of the invention, the user registration web page 170 further comprises a social security data entry field 200. According to yet another alternative embodiment of the invention, the user registration web page 170 further comprises a drivers license data entry field 202. According to yet another alternative embodiment of the invention, the user registration web page 170 further comprises an e-mail data entry field 204.

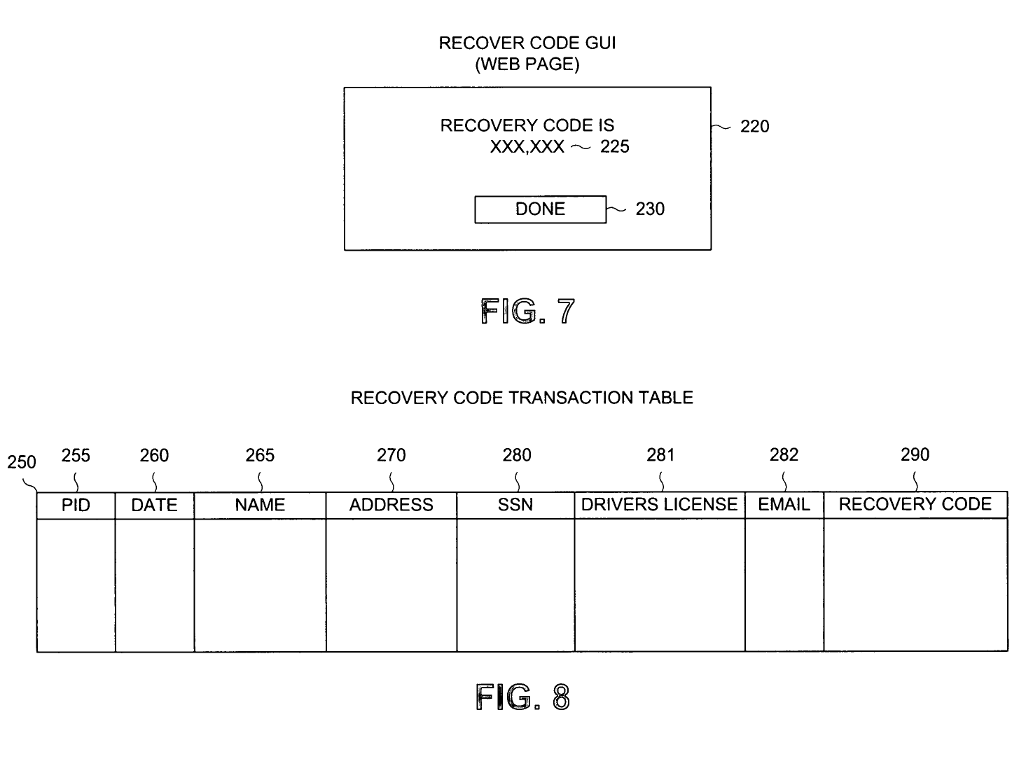

FIG. 7 is a pictorial diagram of an example recovery code presentation GUI embodied as a web page. According to one example embodiment of the present invention, a user is provided with a recovery code once he submits product and user information using the registration web page 170. The product and user registration is stored and a recovery code is determined by the present method. The recovery code may be a sequential number. The recovery code presentation web page 220 is composed by the registration server to include the determined recovery code and is delivered to a current user.

FIG. 8 is a pictorial representation of a recovery code transaction table used by one embodiment of the invention to store recovery code transactions. When the user receives the registration web page 170, the user enters any combination of information in corresponding data entry controls for product identifier, name, address, social security number, driver's license number and e-mail address. This information is stored in a recovery code transaction table 250 comprising a product identifier field 255 and a recover code field 290. Alternative embodiments of the recovery code transaction table 250 comprise one or more of an address field 265, a social security number field 280, a driver's license field 281 and an e-mail field 282. According to one alternative embodiment of the invention, the recovery code transaction table further comprises a date field 260 that is used to store the date of a particular recovery code transaction.

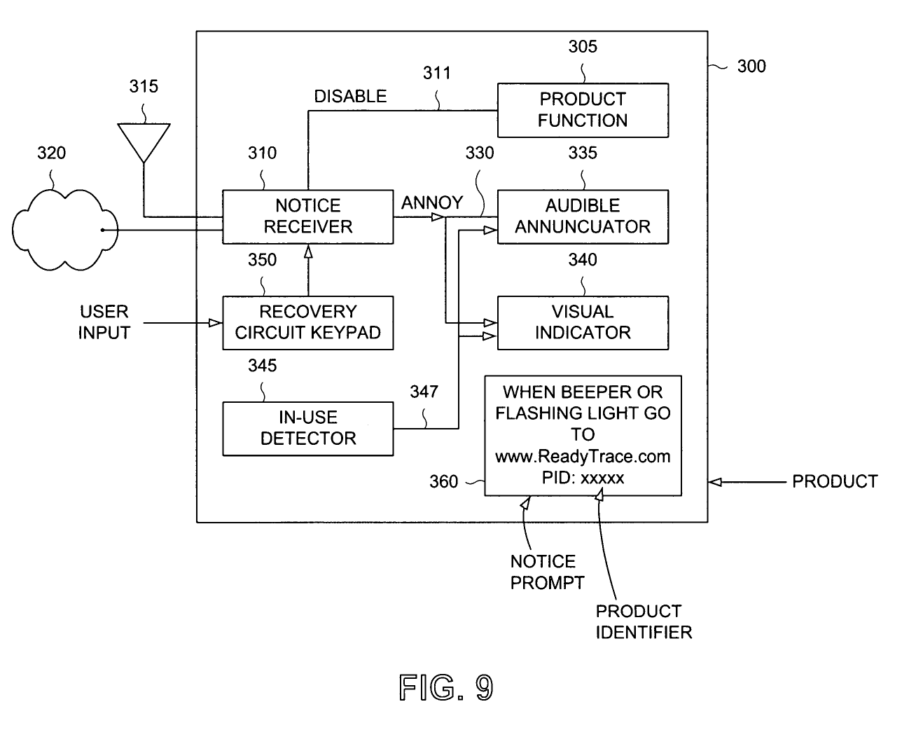

FIG. 9 is a block diagram of a one example embodiment of a product comprising a product notice receiver according to the present attention. According to one example embodiment of the present invention, a product 300 delivered to a user comprises a product function 305 and a notice receiver 310. According to one alternative embodiment of the invention, a product further comprises one or more of an audible and annunciator 335 and a visual indicator 340. According to one example embodiment of the present invention, the notice receiver 310 is commensurate with the teachings of the incorporated reference. The notice receiver 310 upon receiving a notice signal generates an annoyance to a user. According to one example embodiment, the annoyance is generated by means of an ANNOY signal 330 which is used to enable one or more of the audible annunciator 335 and the visual indicator 340. According to one alternative embodiment of the invention, the ANNOY signal 330 is gated by an IN-USE signal 347. The IN-USE signal 347 is generated by an in-use detector 345. The in-use detector 345 senses when the product 300 is in use. When the product is in use, the in-use detector 345 asserts the IN-USE signal 347. According to this alternative embodiment, the audible annunciator 335 and the visual indicator 340 are only active when both the ANNOY signal 330 and the IN-USE signal 347 are both true.

According to one example alternative embodiment of the present invention, a product 300 further comprises a recovery circuit 350. The recovery circuit 350, according to one example embodiment, comprises a keypad or some other data entry device. For example, a single switch may be used. According to one alternative embodiment of the present invention, the notice receiver 310 generates a disable signal 311 upon receiving a notice signal of appropriate urgency, wherein “urgency” is described in the incorporated reference. This disable signal 311 is then used to disable the product function 305 comprising the product 300. In order to re-enable the product function 305, the notice receiver 310 must receive a recovery signal from the recovery circuit 350. The recovery circuit 350, according to this illustrative embodiment of the invention, generates the recovery signal upon successful receipt of a recovery code. According to one example embodiment of the invention, the recovery code is entered by a user, for example by means of a keypad.

In order to obtain a recovery code, the user must register with the registration server 150. According to one alternative embodiment of the invention, the product 300 further comprises a notification prompt 360. The user is directed to the registration server 150 by the notification prompt 360. The notification prompt 316, according to one embodiment, comprises a label directing the user to visit a particular web site (e.g. “www.readytrace.com”) in order to obtain a recovery code. In yet another embodiment, the notification prompt comprises indicia that is integrated directly into the product, for example by means of embossing a notification prompt into the housing of the product 300.

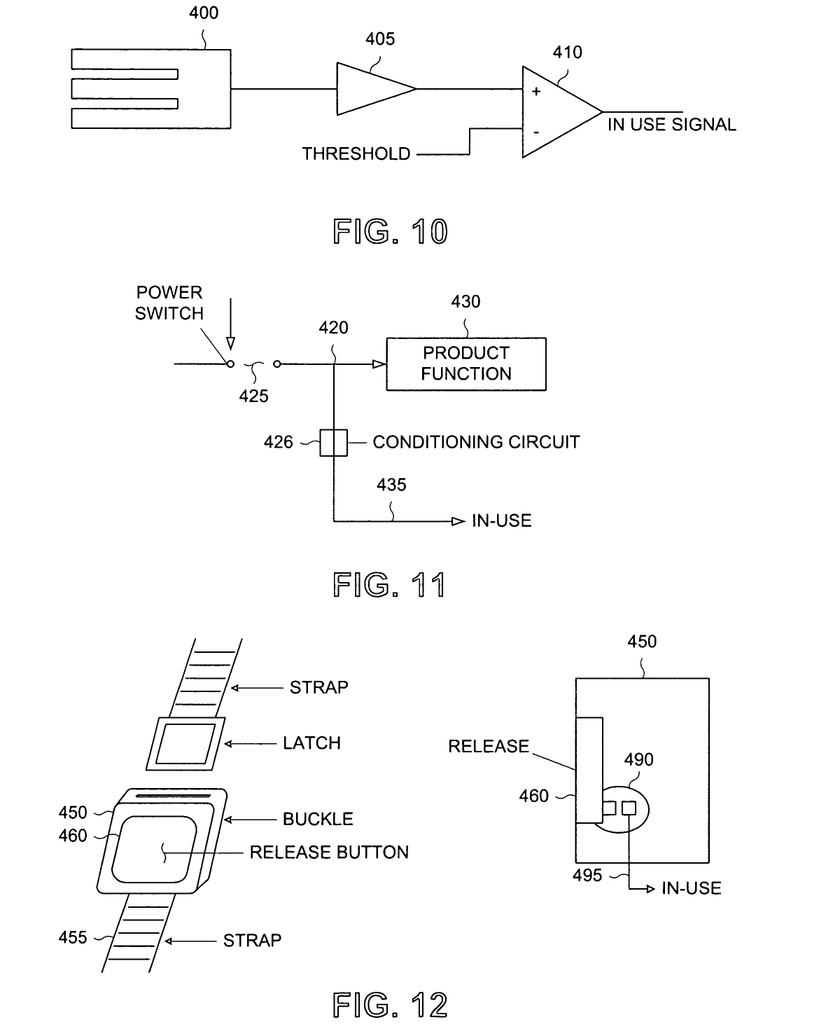

FIG. 10 is a block diagram of one example embodiment of a vibration based in-use detector according to the present invention. According to one alternative embodiment of the invention, the in-use detector 345 comprises an accelerometer 400 (e.g. a micromachined structure comprising an integrated circuit) and appropriate sensing circuitry. Sensing circuitry, according to one alternative embodiment, comprises an amplifier 405 and a comparator 410. The comparator 410 generates the IN-USE signal 347 when the amount of a vibration sensed by accelerometer 400 exceeds a pre-established threshold.

FIG. 11 is a block diagram of one example embodiment of a power switch based in-use detector according to the present invention. According to this example embodiment, the in-use detector comprises a conditioning circuit 426 that generates the IN-USE signal 347 as a derivative of power 420 that is applied to the product function 430, for example by means of a power switch 425.

FIG. 12 is a pictorial diagram of a mechanical operation sensor based in-use detector according to the present invention. Some products comprise mechanical latches and/or latch-buckle assemblies, the state of which may be used to infer the operational state of the product 300. For example, a child car seat comprises a latch 470 and buckle 450 which are used to secure a child into the car seat by means of a first strap 480 and a second strap 455. Generally, the latch 470 is inserted into the buckle 450. According to one example embodiment, a sensor 490 is used to determine if the latch 470 has been inserted into the buckle 450. According to another alternative embodiment, the sensor 490 is used to determine when the latch 470 is released from the buckle 450 by means of the release but a 460. In either case, a sensor 490 generates an IN-USE signal 495 according to the state of the latch 470. For example, the IN-USE signal 495 is asserted when the latch is inserted into the buckle 450. According to yet another example embodiment, the IN-USE signal 495 is asserted when the release button 460 is actuated.

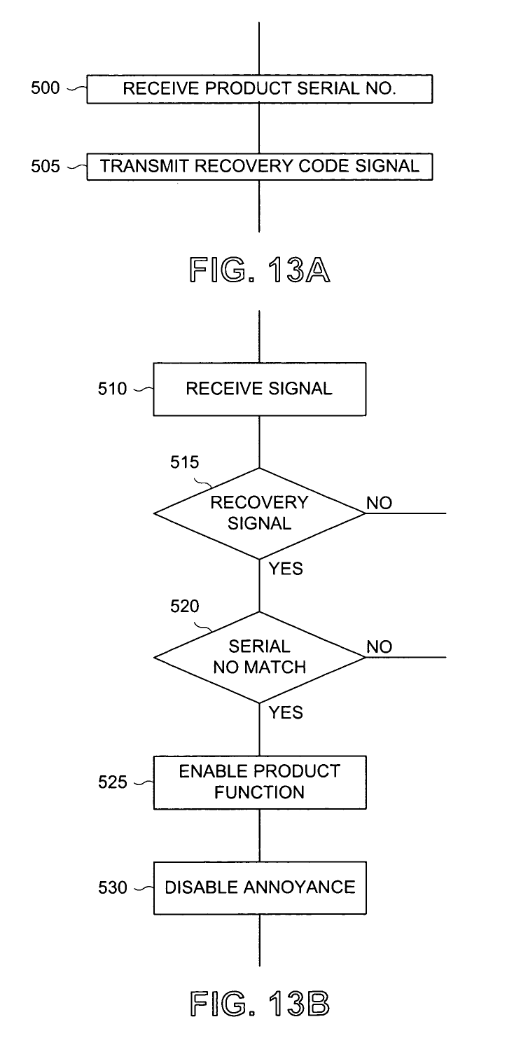

FIG. 13A is a flow diagram that depicts additional process steps for conveying a recovery code in response to a user request received by the registration server according to the present invention. The flow diagram of FIG. 4 depicts a manual method for providing a user with a recovery code. According to the flow diagram of FIG. 4, a user receives a recovery code and then must manually enter the recovery code into a product 300 (e.g. by means of a keypad). According to this alternative method, a product serial number is also received from the user (step 500). A recovery code signal is then transmitted directly to the product (step 505).

FIG. 13B is a flow diagram that depicts an alternative method for receiving a recovery code in a product according to the present invention. According to this alternative method, the notice receiver associated with a product receives a signal 510. A special signal, call a recovery signal, is transmitted in order to conveying a recovery code to the product 300. It should be noted that the signal received by the product is received according to a product identifier as described in the incorporated reference. Once a signal is received, the method provides for recognizing a recovery signal (step 515). When a recovery signal is recognized, a serial number match (step 520) is performed. If the serial number of the product 300 matches the serial number contained in the recovery signal, the product is re-enabled (step 525). Optionally, any annoyance commensurate with the teachings of the present method is also disabled (step 530).

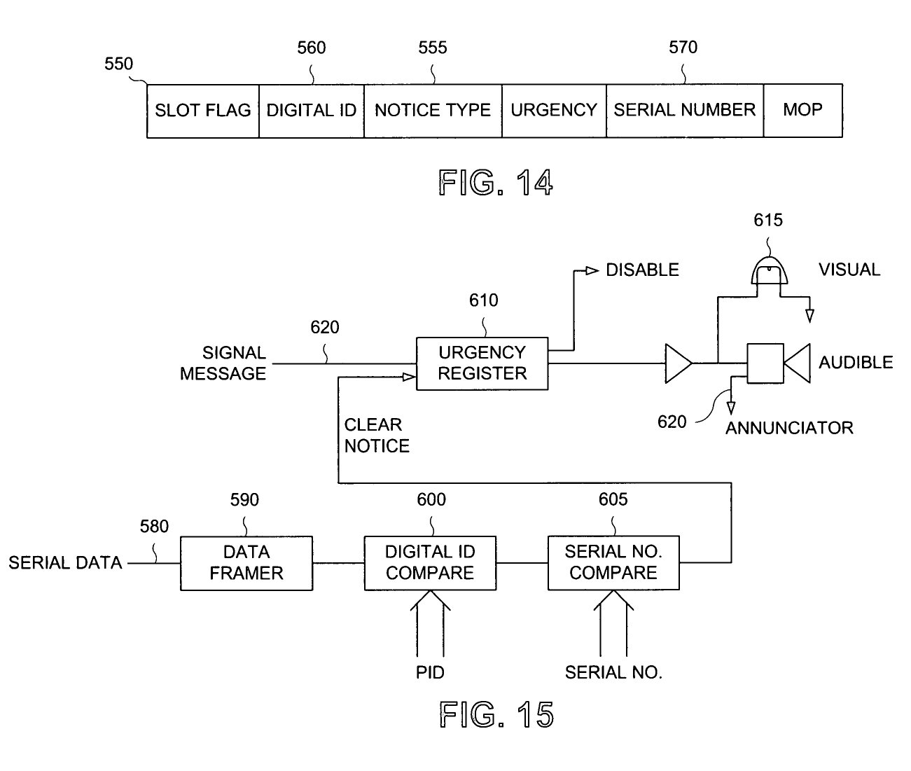

FIG. 14 is a pictorial representation of a notice message comprising a recovery signal according to the present invention. Referring to the incorporated reference, a message is received according to a digital identifier 560. This digital identifier and its function is described fully in the incorporated reference. A notice type indicator 555 is used to determine the type of message addressed to a product according to the digital identifier 560. A special code, which may be varied by application and is not intended to limit the present invention, is used to identify a recovery signal. Once identified as a recovery signal, a serial number 570 contained in the signal message is compared against a serial number for one particular product 300. It should be noted that the serial number for the product is generally programmed into the product notice receiver associated with the product. Upon a successful comparison, the product is re-enabled.

FIG. 15 as a block diagram of a product notice receiver based on the incorporated reference and modified according to the teachings of the present invention. According to one example embodiment, a product notice receiver comprises an urgency register 610, a data framer 590, a digital identifier comparator 600 and a serial number comparator 605. A signal message 620, which may comprise a disable signal, is generally used by the urgency register 610 as a basis for user annoyance and product disablement according to the teachings of the incorporated reference. According to this alternative embodiment, serial data 580 received from a detector circuit is framed by a data framer 590. The digital identifier portion of a signal message constructed by the data framer 590 is compared against a product identifier. This product identifier is generally programmed into a product notice receiver associated with a particular model of product. In the case of a recovery signal, the serial number portion of the signal is compared against a serial number. When both the digital identifier comparator 600 and the serial number comparator 605 produce positive results, the urgency register 610 comprising the product notice receiver is cleared. Hence, any annoyance (e.g. visual indicator 615 and/or audible annunciator 620) is also disabled.

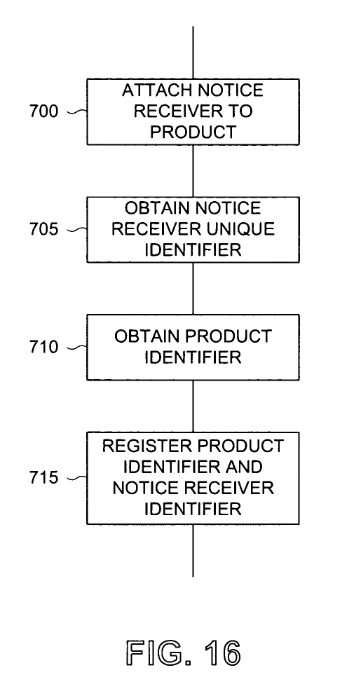

FIG. 16 to diagram that depicts one alternative method of associating a notice receiver with a product according to the present invention. According to this alternative method, a notice receiver may be physically attached to a product. It should be noted that this step is optional. For example, a notice receiver for a particular product may be placed in any convenient location so as to impart to a user and indication of a product notice. Considering one potential use case, a product notice receiver associated with a baby car seat may be placed on an appliance (e.g. a refrigerator). Such notice receiver is identified by a unique identifier (step 705). According to this alternative method, the product identifier for the product is obtained (step 710). The product identifier for the product may comprise any combination of a make/model, serial number, a UPC code, and manufacturing lot date code. This information is then registered together with the unique identifier that identifies the notice receiver (step 715). Hence, when a notice signal is issued, it will be addressed to the product notice receiver identified by the unique identifier associated with the product identifier.

While this invention has been described in terms of several preferred embodiments, it is contemplated that alternatives, modifications, permutations, and equivalents thereof will become apparent to those skilled in the art upon a reading of the specification and study of the drawings. It is therefore intended that the true spirit and scope of the present invention include all such alternatives, modifications, permutations, and equivalents.

What is claimed is:

1. A method for receiving a product notice:
producing a product; and
associating a notice receiver with the product.

2. The method of claim 1 wherein associating a notice receiver with the product comprises:
integrating a notice receiver in the product; and
programming the notice receiver with a product identifier.

3. The method of claim 2 wherein programming the notice receiver with a product identifier comprises programming the notice receiver with at least one of a stock keeping unit number, a serial number, a manufacturing lot number and a manufacturing date code.

4. The method of claim 1 further comprising:
receiving a product notice signal; and
annoying a user when a hazard notice is included in the received product notice signal.

5. The method of claim 4 further comprising:
receiving a recovery code; and
discontinuing annoyance of the user when the recovery code is valid.

6. The method of claim 5 wherein receiving a recovery code comprises perceiving one or more user actions.

7. The method of claim 1 further comprising:
receiving a product notice signal;
determining if the product is in-use; and
annoying a user when a hazard notice is included in the received product notice signal and when the product is in-use.

8. The method of claim 7 further comprising suspending annoyance of the user when the product in no longer in use.

9. The method of claim 7 wherein determining if the product is in-use comprises at least one of sensing a vibration level experienced by the product, sensing the application of power to the product and detecting the actuation of a mechanical component included in the product.

10. The method of claim 1 further comprising:
receiving a product notice signal; and
disabling a product function when a hazard notice is included in the received product notice signal.

11. The method of claim 10 further comprising re-enabling a product function when a recovery code is received.

12. The method of claim 1 further comprising providing user instructions that can be followed when a notice signal is received by the notice receiver.

13. A product comprising:
product functional component; and
notice receiver capable of generating an annoyance signal when a product notice is received.

14. The product of claim 13 wherein the notice receiver is integrated into the product and programmed with a product identifier.

15. The product of claim 14 wherein the notice receiver is programmed with at least one of a stock keeping unit number, a serial number, a manufacturing lot number and a manufacturing date code.

16. The product of claim 13 further comprising at least one of an audible annunciator and a visual indicator that is responsive to the annoyance signal.

17. The product of claim 13 further comprising a recovery circuit capable of directing a recovery signal to the product notice receiver when a valid recovery code is received and wherein the notice receiver suspends the annoyance signal in response to the recovery signal.

18. The product of claim 17 wherein the recovery circuit comprises a data entry device.

19. The product of claim 13 further comprising in-use detector capable of generating an in-use signal when the product is in-use and wherein the annoyance signal is conditioned according to the in-use signal.

20. The product of claim 19 wherein the in-use detector comprises at least one of a vibration sensor, a power sensor and a actuation sensor.

21. The product of claim 13 wherein the notice receiver is further capable of generating a product disable signal when a notice signal is received and wherein the product function component is disabled according to the product disable signal.

22. The product of claim 21 further comprising a recovery circuit capable of directing a recovery signal to the product notice receiver when a valid recovery code is received and wherein the notice receiver suspends the product disable signal in response to the recovery signal.

23. The product of claim 13 further comprising indicia that includes directions for a user to follow when at least an audible annunciator and a visual indicator are activated by the annoy signal.
